(19) United States
(12) Patent Application Publication
(10) Pub. No.: US 2024/0098697 A1
(43) Pub. Date: Mar. 21, 2024

(54) METHOD, DEVICE, AND SYSTEM FOR PAGING INDICATION IN WIRELESS NETWORKS

(71) Applicant: ZTE Corporation, Shenzhen (CN)

(72) Inventors: Focai PENG, Shenzhen (CN); Mengzhu CHEN, Shenzhen (CN); Jun XU, Shenzhen (CN); Xuan MA, Shenzhen (CN); Qiujin GUO, Shenzhen (CN); Xiaoying MA, Shenzhen (CN)

(73) Assignee: ZTE Corporation, Shenzhen (CN)

(21) Appl. No.: 18/521,078

(22) Filed: Nov. 28, 2023

Related U.S. Application Data
(63) Continuation of application No. PCT/CN2021/121553, filed on Sep. 29, 2021.

(51) Int. Cl. H04W 68/02; H04L 1/00; H04W 72/232

(52) U.S. Cl. CPC H04W 68/02; H04L 1/0003; H04L 1/0061; H04W 72/232

(57) ABSTRACT

This disclosure relates generally to a method, device, and system for transmitting and receiving paging indication in wireless communications. One method performed by a UE n an idle or an inactive state including receiving a Downlink Control Information (DCI) from a wireless communication node, wherein the DCI is scramble by a Radio Network Temporary Identification (RNTI) and comprises a paging indication, and wherein the paging indication indicates whether the UE is to receive a next coming paging occasion; resolving the paging indication from the DCI in response to determining that a predetermined condition is met; and determining whether the UE is to receive the next coming paging occasion based on the paging indication.

### TECHNICAL FIELD

This disclosure is directed generally to wireless communications, and particularly to a method, device, and system for transmitting and receiving paging indication.

### BACKGROUND

Controlling power consumption and reducing energy cost are critical for developing and deploying a wireless communication network. In a wireless communication employing various paging mechanisms, increasing paging success rate while reducing power consumption has always been an important goal. Efficient signaling between the wireless communication network and the mobile devices in a paging process is critical for reducing false paging detection rate and improving power efficiency.

### SUMMARY

This disclosure is directed to a method, device, and system for transmitting and receiving paging indication in wireless communications.

In some embodiments, a method performed by a wireless communication node in a wireless network is disclosed. The method may include determining whether a predetermined condition is met; and in response to the predetermined condition being met, transmitting a Downlink Control Information (DCI) to a UE in the wireless network, wherein the DCI is scramble by a Radio Network Temporary Identification (RNTI) and comprises a paging indication, and wherein the paging indication indicates whether the UE is to receive a next coming paging occasion.

In some embodiments, a method performed by a UE in a wireless network is disclosed. The method may include receiving a Downlink Control Information (DCI) from a wireless communication node in the wireless network, wherein the DCI is scramble by a Radio Network Temporary Identification (RNTI) and comprises a paging indication, and wherein the paging indication indicates whether the UE is to receive a next coming paging occasion; resolving the paging indication from the DCI in response to determining that a predetermined condition is met; and determining whether the UE is to receive the next coming paging occasion based on the paging indication.

In some embodiments, there is a UE and/or a wireless communication node comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4a shows an example paging mechanism without paging indication.

FIG. 4b shows an example paging mechanism with paging indication.

FIG. 5 shows an example Downlink Control Information (DCI) fields re-interpretation when a pre-condition is met.

FIG. 6 show a simulation result bases on an embodiment of this disclosure.

FIG. 7 show another simulation result based on an embodiment of this disclosure.

FIG. 8 show another simulation result based on an embodiment of this disclosure.

### DETAILED DESCRIPTION

### Wireless Communication Network

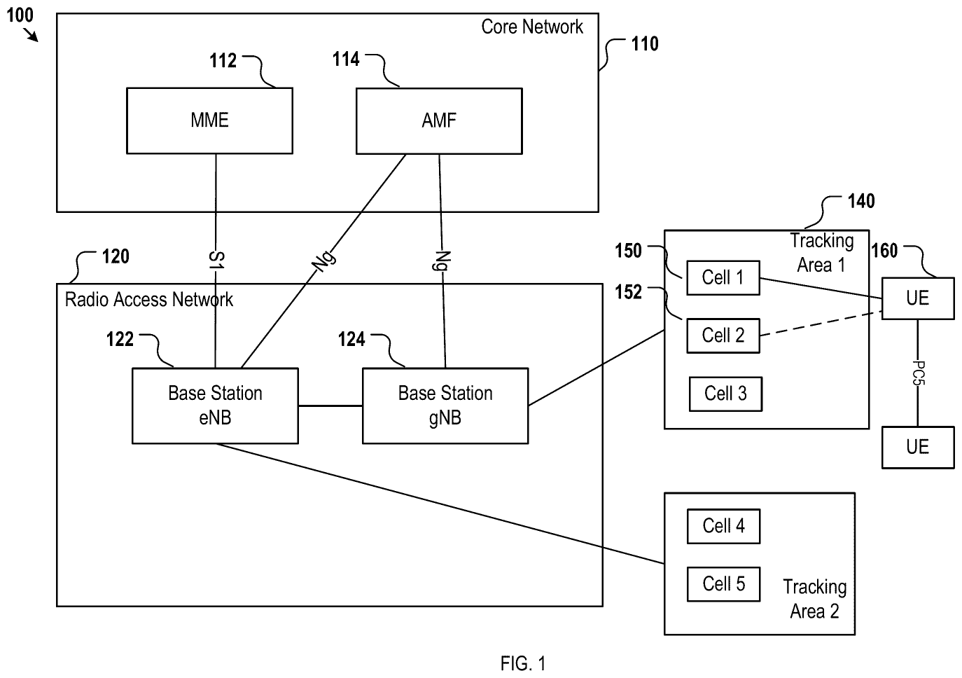

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, or a Next generation NodeB (gNB) for 5G New Radio (NR), or any other type of signal transmitting/receiving device such as a UMTS NodeB. The eNB 122 may communicate with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the at least one DU may be co-located, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the at least one ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

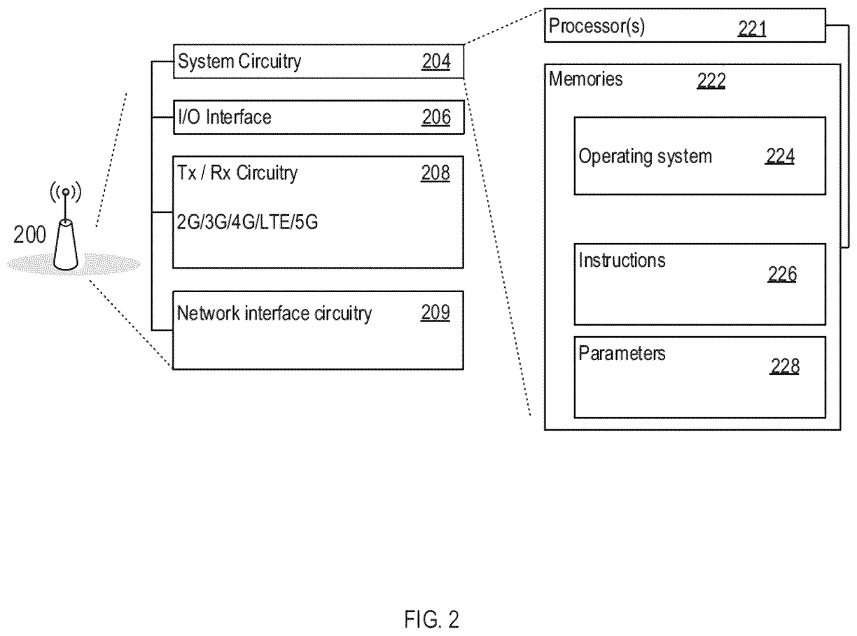

FIG. 2 shows an example of electronic device 200 to implement a network base station (e.g., a radio access network node), a core network (CN), and/or an operation and maintenance (OAM). In one implementation, the example electronic device 200 may include radio transmitting/receiving (Tx/Rx) circuitry 208 for transmitting/receiving communication information with UEs and/or other base stations. The electronic device 200 may also include network interface circuitry 209 for communication with other base stations and/or a core network. The network interface circuitry may be based on optical or wireline interconnects, Ethernet, and/or other data transmission mediums/protocols. The electronic device 200 may include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for execution by the one or more of the processors 221 to perform the functions of a network node. The parameters 228 may include parameters to support execution of the instructions 226. For example, the parameters may include network protocol settings, bandwidth parameters, radio frequency mapping assignments, and/or other parameters.

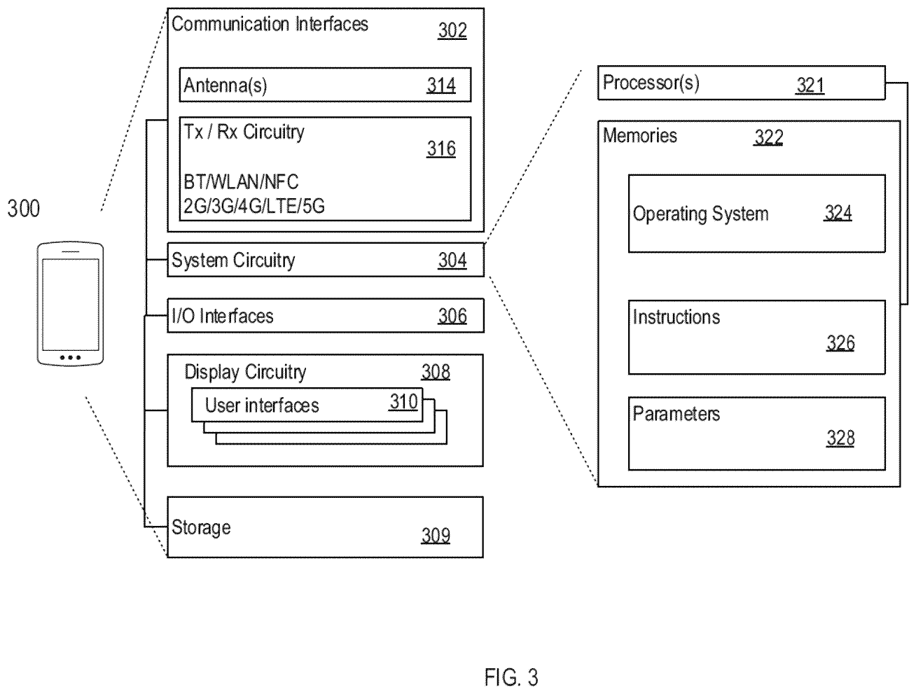

FIG. 3 shows an example of an electronic device to implement a terminal device 300 (for example, a user equipment (UE)). The UE 300 may be a mobile device, for example, a smart phone or a wireless communication module disposed in any other device. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 may be configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Paging Introduction

In the wireless communication system, a UE may connect with the base station via an Over The Air (OTA) interface. If there is an active communication session associated with the UE and the base station, then the status of the connection between the UE and the base station is active and the UE is in an active mode. On the other hand, if there is no active communication session between the UE and the base station, then the UE moves to an idle state or inactive state, for example, a Radio Resource Control (RRC) idle state or an RRC inactive state. The UE limits its usage of the radio resources during the idle state or inactive state and may reduce power consumption by using various techniques including but not limited to Discontinuous Reception (DRX).

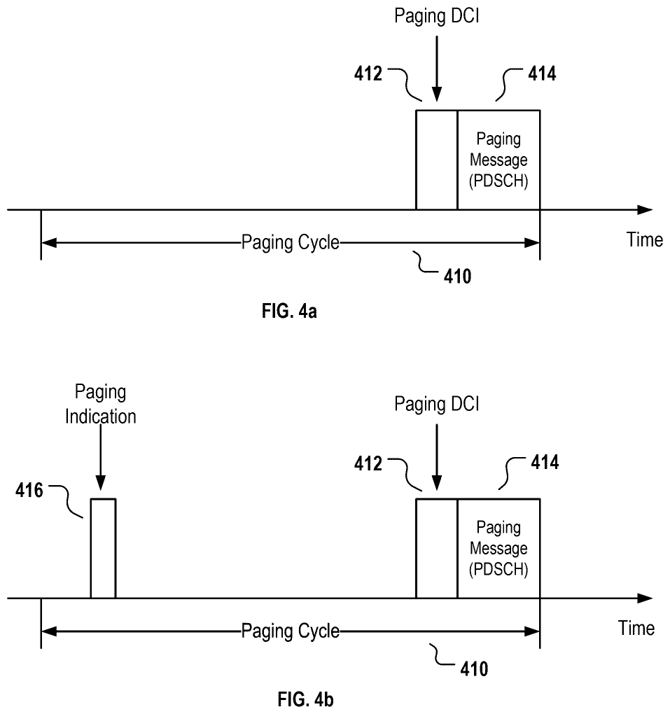

In DRX, resource monitoring and communication activities are managed in cycles, referred to as DRX cycles, or paging cycles. FIG. 4a illustrates an exemplary implementation of a paging cycle 410. In each paging cycle, a UE in the idle or inactive state may enter into a sleeping mode to reduce battery consumption. However, the UE still needs to receive paging DCI 412 in every paging cycle at a particular time point, for example, a paging occasion (PO). In some embodiments, the PO may also be referred to as a paging DCI. The paging DCI 412 may be transmitted on a physical downlink control channel (PDCCH). The format of the paging DCI 412 may include a DCI format 1_0.

After receiving the paging DCI 412, the UE may further receive a paging message 414 which is scheduled by the paging DCI 412 and is carried on a physical downlink shared channel (PDSCH). However, the paging message 414 may target another UE and may not be for this UE. For example, in a case that the paging message 414 does not contain the 5th Generation System Temporary Mobile Subscription Identifier (5G-S-TMSI) of this UE, a false detection may occur if the UE receives and decodes paging messages not targeting itself. Such false detection leads to energy waste for this UE. Therefore, if the UE can avoid detecting paging message not intended for itself, power consumption may be reduced.

In some implementations, an indication mechanism may be employed in a paging process. As shown in FIG. 4b, before the UE receives a paging message, or before a paging DCI scheduling the paging message, a paging indication 416 may be transmitted to the UE to inform the UE to skip a reception of the paging message 414 and/or the paging DCI 412. The UE may then remain it the sleeping mode during the corresponding PO. The paging indication may also be referred to as paging earlier indication. As the name suggests, the paging earlier indication intends to give a UE an early indication whether the UE needs to wake up and take action (i.e., receive paging message and/or paging DCI).

In some implementations, in the wireless communication network, UEs may be assigned or configured into different paging groups (or UE groups). For example, there may be 10 paging groups, each paging group containing 10 UEs. The paging indication 416 (or may be referred to as paging indication signal, paging indication information) may indicate targeted paging group(s). If the UE does not belong to any targeted paging group, then the UE may skip the reception of paging message and/or paging DCI.

### Send Paging Indication

A base station may send a paging indication to the UE via a control message, for example, a DCI.

The DCI includes multiple non-reserved fields. Each non-reserved field may carry different type of information. For example, a Modulation and Coding Scheme (MCS) field in the DCI may convey MCS related information; a Frequency domain resource assignment field may convey frequency domain resource allocation information, etc. The DCI may also include a reserved bits field (or reserved field) which contains multiple reserved bits.

In this disclosure, to at least re-use the existing DCI and improve signaling and decoding efficiency, various embodiments are disclosed to re-interpret or re-purpose one or more DCI fields. The re-interpretation may be based on a pre-condition which will be described in great detail below. Under such implementations, a DCI field may possess a polymorphism property. That is, in a default condition, the DCI field is interpreted as carrying default (or original) information, whereas when the pre-condition is satisfied, the same DCI field is interpreted as carrying different type of information other than the default information. For example, under default condition, the MCS field carries MCS related information. When a pre-condition is met, the MCS field may carry the paging indication. For another example, under default condition, the reserved field is reserved. When a pre-condition is met, the reserved field may be used to carry the paging information.

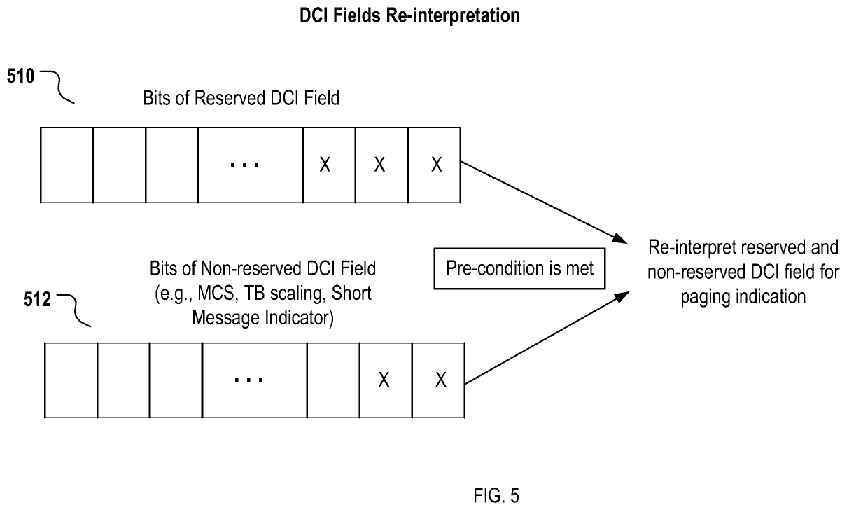

FIG. 5 illustrates an example implementation of DCI fields re-interpretation. The DCI may include a reserved DCI field 510 and a non-reserved field 512, each of which contains multiple bits. When a pre-condition is met, some bits as marked in each field are re-interpreted as carrying paging indication information.

In some implementations, both reserved field and non-reserved field may be used for joint paging indication.

In some implementations, only reserved field(s) is used.

In some implementations, only non-reserved field(s) is/are used.

In some implementations, all bits in a field are used.

In some implementations, only a portion of the bits of a field is used. The selection of the portion of the bits may be pre-determined or configured by higher layer signaling.

In some implementations, a bitmap formed by the DCI field(s) may be used for paging indication. For example, each bit in the bitmap corresponds to or indicate a paging group. For example, when a bit is set to “1”, the corresponding paging group is selected or targeted; when bit is set to “0”, the corresponding paging group is not selected.

In some implementations, the codepoint in the DCI field(s) may be used for paging indication. For example, each codepoint corresponds to a paging group. When the field is set to a particular codepoint, the corresponding paging group is selected or targeted. The codepoint is the binary value of the bits in the DCI field. For example, if the DCI field contains 3 bits set to binary “101”, then the codepoint is decimal 5.

### DCI Field Re-interpretation Pre-condition

The pre-condition for DCI field re-interpretation may include a particular DCI field being set to a specific value, or multiple DCI fields each being set to a specific value. Table 1 below shows exemplary DCI values for indicating a pre-condition.

TABLE 1
Exemplary DCI Field Re-interpretation Pre-conditions

| Field Name | Field Value |
|---|---|
| Short Messages Indicator | 2 bits, each bit set to zero. |
| Short Messages | 8 bits, all bits set to zero. |
| Frequency domain | [log₂(N_{RB}^{DL, BWP} (N_{RB}^{DL, BWP} + 1)/2)] bits, all bits set to zero. |
| resource assignment | Where N_{RB}^{DL, BWP} is the size of control resource set (CORESET) |
| | 0 in the unit of Resource Block (RB). |
| | Alternatively, these bits may also be set to a pre-determined |
| | value. For a CORESET 0 with 24/48/96 RBs, this field has |
| | 9/11/13 bits, respectively. For example, for a CORESET 0 with |
| | 24 RBs, 9 bits may be set as 312~511 in decimal. For a |
| | CORESET 0 with 48 RBs, 11 bits may be set as 2047 in |
| | decimal. For a CORESET 0 with 96 RBs, 13 bits may be set as |
| | 8191 in decimal. |
| Time domain resource | 8 bits, all bits set to zero. |
| assignment | |
| Virtual Resource Block to | 1 bit, set to zero. |
| Physical Resource Block | |
| (VRB-to-PRB) mapping | |
| Modulation and Coding | 5 bits, all bits set to zero. |
| Scheme (MCS) | |
| Transport Block (TB) | 2 bits, all bits set to one. |
| scaling | |

For example, as shown in Table 1, the pre-condition may be that the MCS field is set to zero, or the TB scaling field is set to one. For another example, the pre-condition may be that the MCS field is set to zero whereas the TB scaling field is set to one.

In some embodiments, when the UE decodes the DCI, if the UE determines that the aforementioned pre-condition is met, the UE may interpret the reserved field as carrying paging information. For example, the UE may interpret that the whole reserved field is used for carrying paging information, or the UE may interpret that partial bits of the reserved field are used for carrying paging information.

Various embodiments for implementing paging indication are described in further detail below.

### Embodiment 1

In this embodiment, the paging indication may be transmitted from a base station to a UE via a DCI. The DCI may be a format 1_0 DCI with cyclic redundancy check (CRC) scrambled by a Paging Radio Network Temporary Identification (P-RNTI). This particular DCI format has an identical bit size as a DCI that schedules system information (SI). The DCI includes non-reserved fields as listed in Table 1 above.

As described in Table 1, these non-reserved DCI fields may be used for indicating DCI re-interpretation when setting to a specific value. The specific value of each field listed in Table 1 is for exemplary purpose and may be set to other pre-determined values. For example, the bits in each field may be set to all 1, all 0, or other pre-determined patterns.

Some other exemplary pre-conditions are listed below.

In one implementation, the pre-condition may be that, in the DCI, all the bits before the TB scaling bits are set to zero and the TB scaling bits are all one (i.e., ‘11’).

In another implementation, the pre-condition may be that the value corresponding to the MCS fields is a reserved value (e.g., 29, 30, 31).

In another implementation, the pre-condition may be that the value corresponding to the MCS field indicates a modulation order that is higher than 2 (e.g., 10, 11, . . . , 28). Alternatively, the pre-condition may be that the value corresponding to the MCS field is higher than or equal to a specific value (e.g., 8, 9, 10, . . . , 31).

In another implementation, the pre-condition may be that the value corresponding to the MCS field is a specific value (e.g., 31, all one in binary), and the number of RBs allocated as indicated by the “Frequency domain resource assignment” field is a specific value (e.g., all 1, or all 0 in binary). Alternatively, the pre-condition may be that the value corresponding to the MCS field is a specific value (e.g., 31, all one in binary) and the number of RBs allocated as indicated by the “Frequency domain resource assignment” field is less than or equal to a specific value (e.g., 4).

The reserved bits in the reserved bits field may have 8 bits, for example, when a cell is operated in a shared spectrum channel access mode. Otherwise the reserved bits field may have 6 bits.

In one implementation, when there are 8 reserved bits which may be interpreted for paging indication, if the number of paging groups (N) is less than or equal to 8, then the first N bits may be used for paging indication (e.g., one bit for one paging group) while the rest 8-N bit(s) of the 8 bits remains reserved.

Likewise, when there are 6 reserved bits which may be interpreted for paging indication, if the number of groups (N) is less than or equal to 6, then the first N bits may be used for paging indication (e.g., one bit for one paging group) while the rest 6-N bit(s) of the 6 bits remains reserved.

In one implementation, when there are 6 reserved bits which may be interpreted for paging indication, if the number of groups N is greater than 6, then the first M=5 bits may be used for paging indication (e.g., one bit for one paging group) for the first M paging groups while the last bit may be used to indicate the last N-M paging group(s). See Table 2 below for an example. For simplicity, the group in the table refers to the paging group.

TABLE 2
Example Paging Information Interpretation

| Reserved Bit | Interpretation |
|---|---|
| First bit | Address the first group. |
| Second bit | Address the second group. |
| Third bit | Address the third group. |
| Fourth bit | Address the fourth group. |
| Fifth bit | Address the fifth group. |
| Sixth bit | Address the sixth, seventh and eighth group. |

In one implementation, when the bit used for paging indication is set to “1”, the corresponding paging group is targeted. The UE in the targeted paging group will wake up and receive a coming paging DCI in a next PO, and the UE may further need to receive the paging message from the PDSCH according to the received paging DCI. Otherwise when the bit used for paging indication is set to “0”, the addressed paging group is not targeted. The UE in the un-targeted paging group will remain in sleep mode, or skip the reception of the next PO and/or the paging message. For example, in Table 2, if the second bit is set to 1, the addressed paging group (i.e., the second paging group) is targeted. If the UE is in the second paging group, then the UE would wake up in the next PO to detect the paging DCI and may further receive the paging message according to the received paging DCI. For another example, in Table 2, if the third bit is set to 0, the corresponding paging group (i.e., the third paging group) is not targeted. If the UE is in the third paging group, then the UE will remain in sleep mode during the next PO.

In one implementation, the indication values may be swapped from the above implementation: “1” means not targeted, and “0” means targeted.

In one implementation, if the indication bit is set to “0”, the UE in the corresponding paging group will perform one of: take no action; keep current state; go to sleep; or skip receiving the coming paging DCI, and/or the paging message on the PDSCH.

In one implementation, how UE reacts to the paging indication bit may be determined or configured by higher layer.

In one implementation, when there are 6 reserved bits that may be interpreted for paging indication, if the number of paging groups (N) is greater than 6, then the first M=4 bits are used for paging indication (e.g., one bit for one paging group) for the first M paging groups while the (M+1)^{th} bit is used to indicate the (M+1)^{th} and the (M+2)^{th} group, and the last bit is used to indicate the last N−M−2 paging group(s). See Table 3 below for an example.

TABLE 3
Example Paging Information Interpretation

| Reserved Bit | Interpretation |
|---|---|
| First bit | Address the first group |
| Second bit | Address the second group |
| Third bit | Address the third group |
| Fourth bit | Address the fourth group |
| Fifth bit | Address the fifth and sixth group |
| Sixth bit | Address the seventh and eighth group. |

Alternatively, 4 bits out of the 6 reserved bits may be used to address paging groups with each bit addressing 2 paging groups. The rest 2 bits may be used for other purpose. See Table 4 and Table 5 below for examples.

TABLE 4
Example Paging Information Interpretation

| Reserved Bit | Interpretation |
|---|---|
| First bit | Address the first and second group. |
| Second bit | Address the third and fourth group. |
| Third bit | Address the fifth and sixth group. |
| Fourth bit | Address the seventh and eighth group. |
| Fifth bit | System information change indication (i.e., this bit is used |
| | for other purpose). |
| Sixth bit | Short message indication or Earthquake and Tsunami |
| | Warning System (ETWS) indication (i.e., this bit is used |
| | for other purpose). |

TABLE 5
Example Paging Information Interpretation

| Reserved Bit | Interpretation |
|---|---|
| First bit | Address the first and second group. |
| Second bit | Address the third and fourth group. |
| Third bit | Address the fifth and sixth group. |
| Fourth bit | Address the seventh and eighth group. |
| Fifth bit | Reserved/Not used/For future extension. |
| Sixth bit | Reserved/Not used/For future extension. |

In one implementation, when the DCI is a paging DCI (whose CRC is scrambled by P-RNTI) and the DCI is used to indicate paging information including the paging group, the “Reserved bits” and a sub-set of “MCS bits” may be used to indicate paging group. See Table 6 and Table 7 below for examples.

TABLE 6
Example Paging Information Interpretation

| Bits for Paging Indication | Interpretation |
|---|---|
| First bit of “Reserved bits” | Address the first group. |
| Second bit of “Reserved bits” | Address the second group. |
| Third bit of “Reserved bits” | Address the third group. |
| Fourth bit of “Reserved bits” | Address the fourth group. |
| Fifth bit of “Reserved bits” | Address the fifth group. |
| Sixth bit of “Reserved bits” | Address the sixth group. |
| Last bit of MCS field | Address the seventh and eighth group. |

TABLE 7
Example Paging Information Interpretation

| Bits for Paging Indication | Interpretation |
|---|---|
| Fourth bit of MCS field | Address the first group. |
| Fifth bit of MCS field | Address the second group. |
| First bit of “Reserved bits” | Address the third group. |
| Second bit of “Reserved bits” | Address the fourth group. |
| Third bit of “Reserved bits” | Address the fifth group. |
| Fourth bit of “Reserved bits” | Address the sixth group. |
| Fifth bit of “Reserved bits” | Address the seventh group. |
| Sixth bit of “Reserved bits” | Address the eighth group. |

In one implementation, when the DCI is a paging DCI and the DCI is used to indicate paging information including the paging group, only the “Reserved bits” are used to indicate paging group, and no bit from other non-reserved field is used. Refer to Table 8 below for an example.

TABLE 8
Example Paging Information Interpretation

| Reserved Bit | Interpretation |
|---|---|
| First bit | Address the first group. |
| Second bit | Address the second group. |
| Third bit | Address the third group. |
| Fourth bit | Address the fourth group. |
| Fifth bit | Address the fifth group. |
| Sixth bit | Address the sixth, seventh and eighth group. |

In this embodiment, a UE, upon receiving a DCI configured for paging indication, may know whether the paging group to which the UE belongs is targeted (or paged, indicated). This embodiment is also backward compatible and is transparent to UEs which are not configured to support features in this embodiment, as these UEs may just ignore the paging indication information without causing faulty behavior.

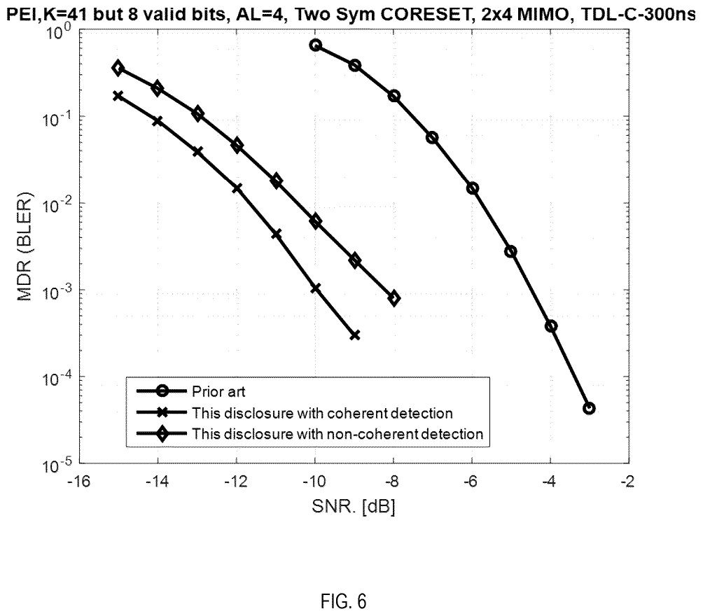

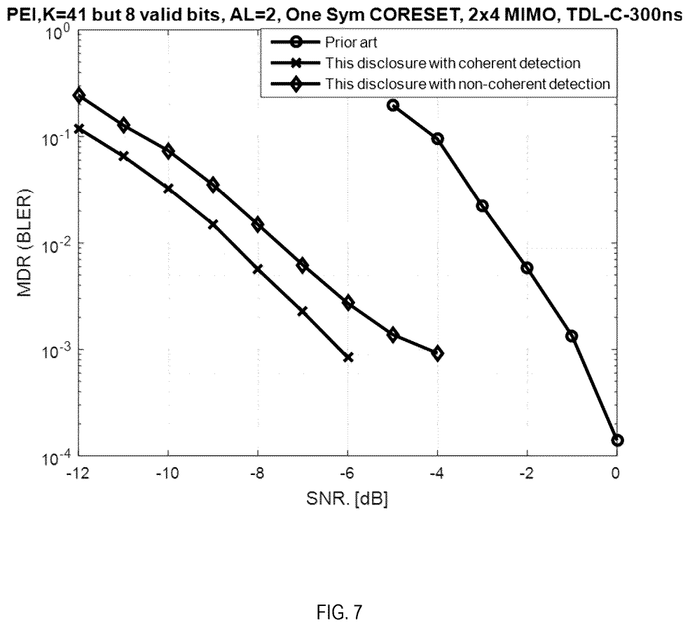

Using this embodiment, the decoding performance of paging indication may be improved. For example, as shown in FIG. 6 and FIG. 7, in coherent detection mode, for Aggregation Level (AL) AL=4 (i.e., 4 control channel elements (CCEs)), the improvement on receiving the paging message or paging-PDSCH is about 6 dB@Bock Error Rate (BLER)=1%; and the improvement is about 6.2 dB @BLER=1% for AL=2. In non-coherent detection mode (with sequence decoding, false detection rate is set to 0.1%), the improvement is about 4.7 dB for AL=4, and 5.1 dB @ BLER=1% for AL=2. Furthermore, the power consumption of UE may be reduced, at least due to reduced false detection rate.

In FIG. 6 and FIG. 7, “K=41 but 4 valid bits” means that the DCI has a payload of 41 bits (in addition to a CRC of 24 bits) but only 8 bits of the 41 bits are useful while the other 41-8=33 bits are fixed. “Two Sym COREST” means this DCI is in a control resource set (CORESET) with two symbols. One Sym COREST” means this DCI is in a control resource set (CORESET) with one symbol. “MIMO” is multiple input and multiple output. “TDL-C-300 ns” is a channel model which has a time delay line with (max) 300 ns delay, type C. BLER is block error rate. MDR is missed detection rate (same as BLER). SNR is signal power to noise power ratio.

### Embodiment 2

In this embodiment, a codepoint of a DCI field may be used as paging indication. A codepoint may be the formed by all the bits in the DCI field, or a partial of all the bits in the DCI field.

In addition to the exemplary pre-conditions for DCI field re-interpretation listed above, some more exemplary pre-conditions are listed below.

In one implementation, the pre-condition may be that the MCS field is set to a specific value, such as MCS=31 (i.e. 5 MCS bits are set to all one).

In one implementation, the pre-condition may be that MCS=31 and the value (i.e., the codepoint) of the TB scaling fields is set to 3 in decimal (“11” in binary format).

In this embodiment, in addition to indicate paging information, the reserved bit field may also indicate other type of information simultaneously. For example, there may be K reserved bits (with K equal to 6, 8, or more) in the reserved bits field. P out of the K bits may be selected to indicate paging group, while the remaining K−P bit(s) may be used for other purpose (e.g., for tracking reference signal (TRS) indication information, channel state information reference signal (CSI-RS) indication, or TRS/CSI-RS availability indication). Both K an P are integers, and P is less than K.

In one implementation, a paging DCI (whose CRC is scrambled by P-RNTI) may be used to indicate paging information. In particular, the codepoint formed by the reserved bits (in the reserved bit field) may be used to indicate paging information.

In one implementation, when a pre-condition (e.g., a pre-condition as described above) is true, information other than paging information may be indicated by re-interpreting existing DCI field. For example, the “Frequency domain resource assignment field”, and/or the “Time domain resource assignment field” may be used to indicate TRS/CSI-RS availability information.

In one implementation, when a pre-condition is met, one or more bit in an DCI field (e.g., the reserved bit field, the “Frequency domain resource assignment field”, or the “Time domain resource assignment field”) may be used to indicate the availability of one TRS/CSI-RS resource set, or the availability of one group of TRS/CSI-RS resource sets.

In one implementation, when a pre-condition is met, a codepoint of an DCI field (e.g., the reserved bit field, the “Frequency domain resource assignment field”, or the “Time domain resource assignment field”) may be used to indicate the availability of one TRS/CSI-RS resource set, or the availability of one group of TRS/CSI-RS resource sets.

In one implementation, when a pre-condition is met, a sub-set (i.e., partial bits) of the re-interpreted field is used to indicate channel state information reference signal (CSI-RS) availability.

In one implementation, when a pre-condition is met, if the reserved bit field has K bits, then P=4 bits out of the K bits may be selected to indicate paging information while the remaining (K−P) bits may be used to indicate TRS/CSI-RS availability information. For example, the decimal value 0, 1, 2, and 3 of the remaining (K−P) bits indicate the availability of the first, the second, the third, and the fourth group of TRS/CSI-RS resource sets, respectively.

In one implementation, when a pre-condition is met, a bitmap formed by a DCI field may be used for TRS/CSI-RS availability indication. For example, the first bit indicates the availability of the first group TRS/CSI-RS resource set, and the second bit indicates the availability of the second group TRS/CSI-RS resource set, etc.

Table 9 below shows an example in which a bitmap formed by 4 bits of the reserved bits field are used to indicate paging information.

TABLE 9
Example Paging and Other Information Interpretation

| Reserved Bits (K = 6 bits) | Interpretation |
|---|---|
| First bit | Reserved/Not used. Or |
| | may be used to indicate |
| | information other than |
| | paging indication |
| | information (e.g., |
| | TRS/CSI-RS availability |
| | indication). |
| Second bit | Reserved/Not used. |
| Decimal value of the last 4 bits is 0 (i.e., | No group is addressed. |
| B0000). “B” represents binary. | |
| Decimal value of the last 4 bits is 1 (i.e., | Address the first group. |
| B0001). | |
| Decimal value of the last 4 bits is 2 (i.e., | Address the second group. |
| B0010). | |
| Decimal value of the last 4 bits is 3 (i.e., | Address the third group. |
| B0011). | |
| Decimal value of the last 4 bits is 4 (i.e., | Address the fourth group. |
| B0100). | |
| Decimal value of the last 4 bits is 5 (i.e., | Address the fifth group. |
| B0101). | |
| Decimal value of the last 4 bits is 6 (i.e., | Address the sixth group. |
| B0110). | |
| Decimal value of the last 4 bits is 7 (i.e., | Address the seventh |
| B0111). | group. |
| Decimal value of the last 4 bits is 8 (i.e., | Address the eighth group. |
| B1000). | |
| Decimal value of the last 4 bits is 15 (i.e., | Address all the groups. |
| B1111). | |
| Decimal value of the last 4 bits is 9~14. | Reserved/Not used. |

In one implementation, one bit of the reserved bits field is used to indicate a UE behavior. For example, the UE behavior may include UE behavior A (e.g., waking up) and UE behavior B (e.g., going to sleep, staying in sleep state). In this implementation, the UE behavior A or B may be indicated at the same time and in the same DCI when indicating paging group.

Table 10 below shows an exemplary DCI reserved bit field re-interpretation in which the second bit is used to indicate UE behavior, and a codepoint is used for paging indication.

TABLE 10
Example Paging Indication and UE Behavior Interpretation

| | Interpretation (Operation |
|---|---|
| Reserved Bits (6 bits) | for Paging indication) |
| First bit | Reserved/Not used. |
| Second bit | Indicate UE behavior, “0” for |
| | UE behavior A, “1” for UE |
| | behavior B. |
| Decimal value of the last P = 4 bits is 0 | No group is addressed. |
| Decimal value of the last P = 4 bits is 1 | Address the first group. |
| . | . |
| . | . |
| . | . |
| Decimal value of the last P = 4 bits is 8 | Address the eighth group |
| Decimal value of the last P = 4 bits is 15 | Address all the groups. |
| Decimal value of the last P = 4 bits is | Reserved/Not used. |
| 9~14. | |

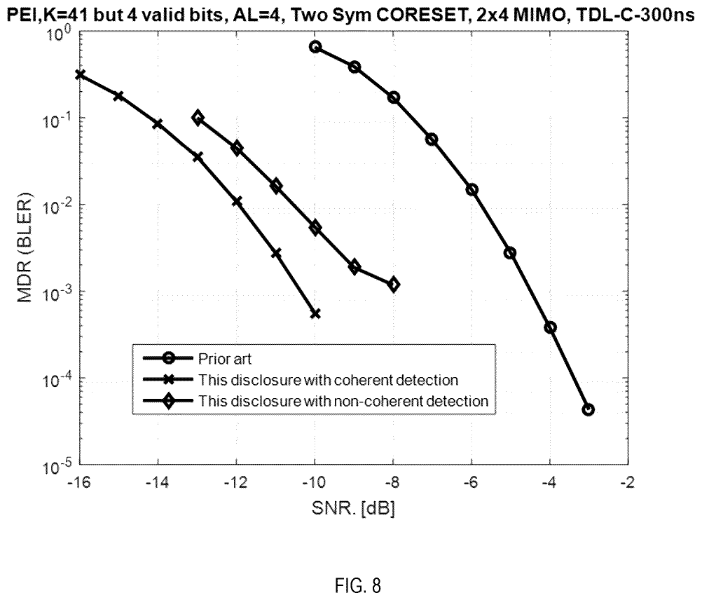

Using this embodiment, the decoding performance of paging indication is improved. For example, as shown in FIG. 8, in coherent detection mode, for Aggregation Level (AL) AL=4, the improvement on receiving the paging message or paging-PDSCH is about 6 dB @ Bock Error Rate (BLER) BLER=1%; and the improvement is about 6.2 dB@BLER-1% for AL=2. In non-coherent detection mode (with sequence decoding, false alarm rate is set to 0.1%), the improvement is about 4.7 dB for AL=4, and 5.1 dB for AL=2. Furthermore, the power consumption of UE may be saved, at least due to reduced false detection rate.

In this embodiment, a UE, upon receiving a DCI configured for paging indication, may know whether the paging group to which the UE belongs is targeted (or paged, indicated). This embodiment is also backward compatible and is transparent to UEs which are not configured to support features in this embodiment, as these UEs may just ignore the paging indication information without causing faulty behavior.

### Embodiment 3

In this embodiment, the paging indication may be transmitted from a base station to a UE via a DCI. The pre-condition for DCI field re-interpretation may be similar to or following the same principles as described in embodiment 1 and is not duplicated.

In one implementation, a 2-bits Short Messages Indicator field in the DCI may be included. An exemplary interpretation of this field is shown in Table 11 below.

TABLE 11
Example Short Messages Indicator Field Interpretation

| Short Messages Indicator | Interpretation |
|---|---|
| 00 | Reserved/For future extension. |
| 01 | System information change is present in |
| | this DCI |
| 10 | The short message is present in this DCI. |
| 11 | Both system information change and short |
| | message are present this DCI. |

The Short Messages field of the DCI has a bit-width of 8. If the “Short Messages Indicator” described above is “00” or “01”, then this bit field is reserved. Otherwise, these bits will carry short messages from higher layer.

The reserved bits in the reserved bits fields may be interpreted as paging indication under certain pre-conditions. For example, when the TB scaling field in the same DCI is set to a pre-determined value, the reserved bits may be interpreted as paging indication. If there are 8 reserved bits in the reserved bits field, each bit may be associated with one paging group (up to 8 paging groups). For 6 reserved bits, an exemplary interpretation is listed in Table 12 below.

TABLE 12
Example Paging Information Interpretation

| Reserved | |
|---|---|
| Bits (6 bits) | Interpretation |
| First bit | 0: the paging indication in the DCI is associated with or |
| | applies to one paging occasion (PO), for example, the |
| | next coming PO. |
| | 1: the paging indication is associated with or applies to |
| | Ns POs, where Ns is number of POs in a paging frame |
| | (PF). Ns may be configured by higher layer signaling. |
| | For example, Ns may be configured to be s 1, 2, or 4. |
| Second bit | Address the first group, e.g., “0” indicates that this |
| | paging group is not being paged; “1” indicates that this |
| | paging group is being paged. |
| Third bit | Address the second group. |
| Fourth bit | Address the third group. |
| Fifth bit | Address the fourth and fifth group. |
| Sixth bit | Address the sixth, seventh and eighth group. |

For 8 reserved bits in the reserved bits field, Table 13 below shows exemplary interpretation of the reserved bits.

TABLE 13
Example Paging Information Interpretation

| Reserved | |
|---|---|
| Bits (8 bits) | Interpretation |
| First bit | Address the first group. |
| Second bit | Address the second group. |
| Third bit | Address the third group. |
| Fourth bit | Address the fourth group. |
| Fifth bit | Address the fifth group. |
| Sixth bit | Address the sixth group. |
| Seventh bit | Address the seventh and eighth group. |
| Eighth bit | 0: the paging indication is associated with or applies to one |
| | paging occasion (PO), for example, the next coming PO. |
| | 1: the paging indication is associated with or applies to Ns |
| | POs, where Ns is number of POs in a paging frame (PF). Ns |
| | may be configured by higher layer signaling. For example, |
| | N_{S} may be configured to be 1, 2, or 4. |

In one implementation, when a pre-condition as described above is met, there are 8 reserved bits in the reserved bits fields which need to be re-interpreted.

In one implementation, when a pre-condition as described above is met, there are up to 8 reserved bits in the reserved bits fields (e.g., 4, 5, 6, 7, or 8 bits) which need to be re-interpreted. The selection of these reserved bits may be pre-determined, or configured by higher layer signalling.

### Embodiment 4

In this embodiment, one or more non-reserved field of the DCI may be combined with the reserved bits field to indicate paging information.

For example, when a pre-condition is met, the VRB-to-PRB mapping field may be re-interpreted to indicate paging information.

For another example, the MCS field may be re-interpreted to indicate paging information. In one implementation, the MCS field has 5 bits. When the first four bits are all set to zero, the last bit may be re-interpreted to indicate paging information.

In this embodiment, more exemplary pre-conditions for DCI field re-interpretation are described below.

For example, the Time domain resource assignment field has 4 bits. The pre-condition may be that all these 4 bits are set to zero.

For another example, the pre-condition may include: the time domain resource assignment field is set to a specific value (e.g., 15 in decimal), and the CRC of the DCI that carries the paging indication is scrambled by P-RNTI. Alternatively, the pre-condition may further include that the DCI is in a common search space. Alternatively, the pre-condition may further include that the DCI is in a PDCCH Type0 common search space.

For another example, the pre-condition may include: the “Frequency domain resource assignment bits” field and the “TB scaling bits” field have a specific value (e.g., all one).

Table 14 below shows exemplary paging information interpretation in which both non-reserved fields and reserve bits field are used.

TABLE 14
Example Paging Information Interpretation (6 bits in reserved bits field)

| Bits in Non-reserved Field | |
|---|---|
| and Reserved Bits Field | Interpretation |
| VRB-to-PRB mapping field (1 bit) | Address the first group. |
| Last bit of MCS field | Address the second group. |
| First bit in Reserved bits | Address the third group. |
| (or other paging indication bits) | |
| Second bit in Reserved bits | Address the fourth group. |
| (or other paging indication bits) | |
| Third bit in Reserved bits | Address the fifth group. |
| (or other paging indication bits) | |
| Fourth bit in Reserved bits | Address the sixth group. |
| (or other paging indication bits) | |
| Fifth bit in Reserved bits | Address the seventh group. |
| (or other paging indication bits) | |
| Sixth bit in Reserved bits | Address the eighth group. |
| (or other paging indication bits) | |

Table 14 above shows only an exemplary manner to use the bits in various fields to indicate paging groups. Other bit combinations following different order to indicate paging groups may also be implemented under the principles described above. For example, the first bit of the reserved bits may be used to indicate the eighth paging group.

Table 15 below shows another exemplary paging information interpretation in which both non-reserved fields and reserve bits field are used.

TABLE 15
Example Paging Information Interpretation (8 bits in reserved bits field)

| Bits in Non-reserved Field | |
|---|---|
| and Reserved Bits Field | Interpretation |
| VRB-to-PRB mapping (1 bit) | Address the first group. |
| Last bit of MCS field | Address the second group. |
| First bit in Reserved bits | Address the third group. |
| (or other paging indication bits) | |
| Second bit in Reserved bits | Address the fourth group. |
| (or other paging indication bits) | |
| Third bit in Reserved bits | Address the fifth group. |
| (or other paging indication bits) | |
| Fourth bit in Reserved bits | Address the sixth group. |
| (or other paging indication bits) | |
| Fifth bit in Reserved bits | Address the seventh group. |
| (or other paging indication bits) | |
| Sixth bit in Reserved bits | Address the eighth group. |
| (or other paging indication bits) | |
| Seventh bit in Reserved bits | Reserved/For future |
| (or other paging indication bits) | extension |
| Eighth bit in Reserved bits | Reserved/For future |
| (or other paging indication bits) | extension |

Table 16 below shows another exemplary paging information interpretation in which both non-reserved fields and reserve bits field are used.

TABLE 16
Example Paging Information Interpretation (8 bits in reserved bits field)

| Bits in Non-reserved Field and | |
|---|---|
| Reserved Bits Field | Interpretation |
| VRB-to-PRB mapping | 0: the paging indication is associated with or |
| | applies to one paging occasion (PO), for |
| | example, the next coming PO. |
| | 1: the paging indication is associated with or |
| | applies to Ns POs, where Ns is number of |
| | POs in a paging frame (PF). Ns may be |
| | configured by higher layer signaling. For |
| | example, N_{S} may be configured to be s 1, 2, |
| | or 4. |
| Last bit of Modulation and coding | Reserved/For future extension or, set as “1”. |
| scheme | |
| First bit in Reserved bits (or other | Address the first group. |
| paging indication bits) | |
| Second bit in Reserved bits (or other | Address the second group. |
| paging indication bits) | |
| Third bit in Reserved bits (or other | Address the third group. |
| paging indication bits) | |
| Fourth bit in Reserved bits (or other | Address the fourth group. |
| paging indication bits) | |
| Fifth bit in Reserved bits (or other | Address the fifth group. |
| paging indication bits) | |
| Sixth bit in Reserved bits (or other | Address the sixth group. |
| paging indication bits) | |
| Seventh bit in Reserved bits (or other | Address the seventh group. |
| paging indication bits) | |
| Eighth bit in Reserved bits (or other | Address the eighth group. |
| paging indication bits) | |

Table 17 below shows another exemplary paging information interpretation in which both non-reserved fields and reserve bits field are used.

TABLE 17
Example Paging Information Interpretation (6 bits in reserved bits field)

| Bits in Non-reserved Field and | |
|---|---|
| Reserved Bits Field | Interpretation |
| VRB-to-PRB mapping | 00: the paging indication is associated with |
| | or applies to one paging occasion (PO), for |
| | example, the next coming PO. |
| | 1: the paging indication is associated with or |
| | applies to Ns POs, where Ns is number of |
| | POs in a paging frame (PF). Ns may be |
| | configured by higher layer signaling. For |
| | example, N_{S} may be configured to be s 1, 2, |
| | or 4. |
| Last bit of MCS field | Address the first group. |
| First bit in Reserved bits (or other | Address the second group. |
| paging indication bits) | |
| Second bit in Reserved bits (or other | Address the third group. |
| paging indication bits) | |
| Third bit in Reserved bits (or other | Address the fourth group. |
| paging indication bits) | |
| Fourth bit in Reserved bits (or other | Address the fifth group. |
| paging indication bits) | |
| Fifth bit in Reserved bits (or other | Address the sixth group. |
| paging indication bits) | |
| Sixth bit in Reserved bits (or other | Address the seventh and eighth group. |
| paging indication bits) | |

In one implementation, the meaning or interpretation of a bit field may depend on a second level condition (where first level condition may be one of the pre-conditions described above). In this case, the first level condition determines whether a DCI field should be interpreted as its default usage, or should be re-interpreted (e.g., re-interpreted for paging indication purpose). Once the first level condition is met, the second level condition further determines how to interpret the field. For example, the meaning of “VRB-to-PRB mapping” filed or the last bit of the Reserved bits field depends on some second level condition. The second level condition may be based on the number of PO in a paging frame (i.e., Ns). Refer to Table 18 below for an example.

TABLE 18
Example Paging Information Interpretation

| Bits in Non-reserved Field and | |
|---|---|
| Reserved Bits Field | Interpretation |
| VRB-to-PRB mapping (1 bit) | If Ns = 1, then this bit will address the eighth |
| | group. Otherwise, “0” indicates that the |
| | paging indication is associated with or applies |
| | to one paging occasion (PO). “1” indicates |
| | that the paging indication is associated with or |
| | applies to Ns POs. |
| Last bit of Modulation and coding | Address the first group. |
| scheme | |
| First bit in Reserved bits (or other | Address the second group |
| paging indication bits) | |
| Second bit in Reserved bits (or other | Address the third group |
| paging indication bits) | |
| Third bit in Reserved bits (or other | Address the fourth group |
| paging indication bits) | |
| Fourth bit in Reserved bits (or other | Address the fifth group |
| paging indication bits) | |
| Fifth bit in Reserved bits (or other | Address the sixth group. |
| paging indication bits) | |
| Sixth bit in Reserved bits (or other | If Ns = 1, then this bit will address the seventh |
| paging indication bits) | group. Otherwise, this bit will address the |
| | seventh and the eighth group. |

### Embodiment 5

In this embodiment, the paging indication may be transmitted from a base station to a UE via a DCI.

In one implementation, the CRC of this DCI may be scrambled by a RNTI different from the P-RNTI. For example, the RNTI may include a system information RNTI (SI-RNTI, 0xFFFF in hex). For another example, the RNTI may be configured by higher layer (e.g., configured as 0xFFFF in hex).

In one implementation, when the CRC of the DCI is scrambled by an RNTI which is different from the P-RNTI, the UE only needs to re-interpret the DCI fields (e.g., non-reserved field or reserved bits field) which carry paging indication information. In one implementation, the UE may further assume that the DCI only contains field(s) for paging indication purpose. In one implementation, the UE may assume that the DCI only contains field(s) for paging indication. In one implementation, the UE may assume that the DCI only contains field(s) for paging indication and/or TRS/CSI-RS availability indication. In one implementation, the UE may assume that the DCI only contains field(s) for paging indication and/or TRS/CSI-RS availability indication and/or Short Messages.

In one implementation, when the CRC of the DCI is scrambled by a RNTI which is different from the P-RNTI (e.g., an SI-RNTI), only w bits out of all the reserved bits in the reserved bits field are used for indicating paging information, where w is the number of paging groups that is configured by higher layer.

In one implementation, only w+1 bits out of all the reserved bits in the reserved bits field are used for indicating paging information, in which w bits indicate paging groups and the additional one bit is used for future extension.

In one implementation, only w+1 bits out of all the reserved bits in the reserved bits field are used for indicating paging information, in which w bits indicate paging groups and the additional one bit is used to indicate UE behavior. The UE behavior may include a UE behavior A (e.g., waking up to receive a coming paging DCI and/or paging message) and a UE behavior B (e.g., going to sleep, keeping at sleep). When the UE behavior is indicated, a UE in a corresponding paging group will follow the indicated behavior. It is to be understood that in some implementations, there is no need to indicate the UE behavior. In this case, the default behavior may be pre-determined.

In this embodiment, a specific value of a DCI field may be used to determine whether other fields need to be re-interpreted. For example, when all bits in the Frequency domain resource assignment field is set to one, or when the Frequency domain resource assignment field is set to a pre-determined value, the VRB-to-PRB mapping field, the MCS field, or the TB scaling field may be re-interpreted as carrying paging indication information.

In this embodiment, a specific value of a DCI field may also carry other paging indication related information. For example, when the Frequency domain resource assignment field is set to decimal 511, it indicates that the paging indication carried in the DCI applies to just one PO (e.g., the next coming PO). When the Frequency domain resource assignment field is set to decimal 510, it indicates that the paging indication carried in the DCI applies to multiple POs (e.g., Ns POs, where Ns is the number of POs in a paging frame). The specific value of the DCI field may be pre-determined or be configure by higher layer.

Similarly, the example above may apply to other DCI fields. For example, a specific value may be set for the time domain resource assignment field, to determine whether other fields need to be re-interpreted.

Table 19 below shows an example in which various non-reserved DCI fields are used to indicate paging information.

TABLE 19
Example Paging Information Interpretation

| Bits for Paging Indication | Interpretation |
|---|---|
| VRB-to-PRB mapping | Address the first group. |
| First bit in MCS field | Address the second group. |
| Second bit in MCS field | Address the third group. |
| Third bit in MCS field | Address the fourth group. |
| Fourth bit in MCS field | Address the fifth group. |
| Fifth bit in MCS field | Address the sixth group. |
| First bit in TB scaling field | Address the seventh group. |
| Second bit in TB scaling field | Address the eighth group. |

Table 20 below shows another example in which various non-reserved DCI fields are used to indicate paging information.

TABLE 20
Example Paging Information Interpretation

| Bits for Paging Indication | Interpretation |
|---|---|
| Frequency domain | All bits set to one (i.e., 511 in decimal for |
| resource assignment | 9 bits): the paging indication in the DCI is |
| | associated with or applies to one paging |
| | occasion (PO), for example, the next |
| | coming PO. |
| | The last bit set as zero while all other bits |
| | set to one (i.e., 510 in decimal for 9 bits): |
| | the paging indication is associated with or |
| | applies to Ns POs, where Ns is number of |
| | POs in a paging frame (PF). Ns may be |
| | configured by higher layer signaling. |
| | For example, N_{S} may be configured to be |
| | s 1, 2, or 4. |
| VRB-to-PRB mapping | Address the first group. |
| First bit in MCS field | Address the second group |
| Second bit MCS field | Address the third group. |
| Third bit in MCS field | Address the fourth group. |
| Fourth bit in MCS field | Address the fifth group. |
| Fifth bit in MCS field | Address the sixth group. |
| First bit in TB scaling field | Address the seventh group. |
| Second bit in TB scaling field | Address the eighth group. |

Table 21 below shows another example in which various non-reserved DCI fields are used to indicate paging information.

TABLE 21
Example Paging Information Interpretation

| Bit fields | Operation for Paging indication |
|---|---|
| VRB-to-PRB mapping | “0”: the paging indication in the DCI is |
| | associated with or applies to one paging |
| | occasion (PO), for example, the next |
| | coming PO. |
| | “1”: the paging indication is associated |
| | with or applies to Ns POs, where Ns is |
| | number of POs in a paging frame (PF). Ns |
| | may be configured by higher layer |
| | For example, N_{S} may be |
| | signaling. For example, Ns may be |
| | configured to be s 1, 2, or 4. |
| First bit in MCS field | Address the first group. |
| Second bit MCS field | Address the second group. |
| Third bit in MCS field | Address the third group. |
| Fourth bit in MCS field | Address the fourth group. |
| Fifth bit in MCS field | Address the fifth group. |
| First bit in TB scaling field | Address the sixth group. |
| Second bit in TB scaling field | Address the seventh and eighth group. |

### Embodiment 6

In this embodiment, the paging indication may be transmitted from a base station to a UE via a DCI. The CRC of the DCI may be scrambled by a power saving RNTI.

The DCI may include a paging indication field which has Y bits (Y is an integer). Each bit corresponds to a paging group. For example, the i-th bit (counting from most significant bit (MSB), or from the least significant bit (LSB)) corresponds to the i-th paging group.

In one implementation, the paging indication field may include an additional bit (i.e., Y+1 bits total). This additional bit may be used to indicate a UE behavior, such as the UE behavior A or UE behavior B as described above.

In one implementation, the paging indication field may include ceil(log 2(Y)) bits where Y is the number of paging groups configured by higher layer, ceil( ) represents a ceiling operation that fetches a minimum integer which is not lower than the operand, and log 2( ) is logarithm of base 2. A codepoint of these bits may be used to indicate paging information.

In this embodiment, the DCI carrying the paging indication information has a small footprint (i.e., the size of the DCI is small). Thus, the signaling overhead is reduced and the coverage performance is improved. Meanwhile, from a UE power consumption perspective, as unnecessary paging reception is avoided from the UE side, the power consumption is reduced.

### Embodiment 7

In this embodiment, in addition to normal paging message scheduling, a paging DCI may be assigned a new function related to paging indication. For example, a paging DCI in a previous paging cycle may carry paging indication for a current paging cycle, or a paging DCI in a current paging cycle may carry paging indication for a next paging cycle.

Similarly, a paging DCI in a previous paging cycle may carry TRS/CSI-RS availability information for a current paging cycle, or a paging DCI in a current paging cycle may carry TRS/CSI-RS availability information for a next paging cycle.

In one implementation, the paging DCI in previous paging frame(s) for one UE may indicate paging indication information (e.g., paging group, UE group, TRS/CSI-RS availability) for a current paging cycle for another UE. Optionally, the time interval between two adjacent paging DCIs is configured to be larger than or equal to a multiple of the duration of a reference duration. The reference duration may include a duration of a paging frame, or a periodicity of a Synchronization Signal Block (SSB). For example, the time interval between two adjacent paging DCIs may be 3 to 6 times of the duration of a paging frame. For another example, the time interval between two adjacent paging DCIs may be 3 periodicities of SSB.

The paging indication may be transmitted from a base station to a UE via a DCI. The CRC of the DCI may be scrambled by a power saving RNTI.

In this embodiment, the value of the short message indicator field may be used by the UE to interpret other fields for paging indication.

For example, when the short message indicator field is “00” or “01” in binary, or the first bit of the short message indicator field is “0” in binary, the short messages field of the DCI may be used for paging indication and/or TRS/CSI-RS availability indication. When the short message indicator field is “10” or “11” in binary, or the first bit of the short message indicator field is “1” in binary, the fourth to eighth bit of the short messages field may be used for paging indication and/or TRS/CSI-RS availability indication.

For another example, when the short message indicator field is “10” in binary, the bits in the following fields may be used for paging indication and/or TRS/CSI-RS availability indication:
the “Frequency domain resource assignment” field;
the “Time domain resource assignment” field;
the VRB-to-PRB mapping field;
the MBS field;
the TB scaling field; or
the reserved bits field.

In one implementation, the bits in the reserved bits field may be divided into two sets. One set may be used for paging indication, and the other set may be used for TRS/CSI-RS availability indication. The indication may be based on bitmap formed by the bits in each set, or the indication may be based on the codepoint of each set.

In one implementation, when the short message indicator field is “00” or “01” in binary, the short messages field may be used for paging group/UE group indication, and the reserved bits field may be used for TRS/CSI-RS availability indication. Alternatively, the short messages field may be used for TRS/CSI-RS availability indication, and the reserved bits field may be used for paging group/UE group indication.

In one implementation, when the short message indicator field is “10” in binary, the “Frequency domain resource assignment” field may be used for paging group/UE group indication, and the reserved bits field may be used for TRS/CSI-RS availability indication. Alternatively, the “Frequency domain resource assignment” field may be used for TRS/CSI-RS availability indication, and the reserved bits field may be used for paging group/UE group indication.

In one implementation, when the short message indicator field is “10” in binary, the “Time domain resource assignment” field may be used for paging group/UE group indication, and the reserved bits field may be used for TRS/CSI-RS availability indication. Alternatively, the “Time domain resource assignment” field may be used for TRS/CSI-RS availability indication, and the reserved bits field may be used for paging group/UE group indication.

### Embodiment 8

In some embodiments, rather than re-using an existing DCI to transmit paging indication information, a new DCI may be created for paging indication and/or TRS/CSI-RS availability indication. The CRC of this new DCI may be scrambled by a P-RNTI, or an RNTI configured by higher layer (e.g., RRC).

In one implementation, when the CRC of the DCI is scrambled by P-RNTI or an RNTI configured by higher layer (e.g., RRC), this DCI may include the following bit field:
paging indication, N bits where N is configured by higher layer. Alternatively, N=8. Alternatively, N=16. Each bit corresponds to a paging group (or UE group).

When the CRC of DCI is scrambled by P-RNTI or an RNTI configured by higher layer (e.g., RRC), this DCI may include the following bit fields with N+M bits in total as the list below. Alternatively, the DCI size (i.e., N+M bits) may be fixed or configured by higher layer. Alternatively, the DCI size (i.e., N+M bits) is 12 (e.g., N=8 for 8 paging groups, M=4 for reserved bits).
paging indication, N bits, where N is configured by higher layer. Alternatively, N=8. Alternatively, N=16. Each bit is corresponding to a paging group (or UE group).
Reserved bits, M bits, where M is fixed or configured by higher layer. Alternatively, the M is identical to the number of “Reserved bits” of DCI of paging PDCCH whose CRC is scrambled by P-RNTI.

In one implementation, when the CRC of a PDCCH-PEI is scrambled by P-RNTI or an RNTI configured by higher layer (e.g., RRC), this PDCCH-PEI may include the following bit fields:
paging indication, N bits, where N is configured by higher layer. Alternatively, N=8. Alternatively, N=16. Each bit corresponds to a paging group (or UE group).
TRS/CSI-RS availability indication, P bits, where P is configured by higher layer.

In one implementation, if the DCI size of the DCI is less than that of the DCI format 1_0 whose CRC is scrambled by SI-RNTI (e.g., 41 bits for a CORESET with 24 RB), then zeros are appended (padded) until it has the identical size with that of the DCI format 1_0 whose CRC is scrambled by SI-RNTI. Alternatively, if the DCI size of the DCI is less than that of the DCI format 1_0 whose CRC is scrambled by P-RNTI, then zeros are appended until it has the identical size with that of the DCI format 1_0 whose CRC is scrambled by P-RNTI.

In one implementation, when the CRC of the DCI is scrambled by P-RNTI or an RNTI configured by higher layer (e.g., RRC), this DCI may include the following bit fields:
paging indication, N bits, where N is configured by higher layer. Alternatively, N=8. Alternatively, N=16. Each bit corresponds to a paging group (or UE group).
TRS/CSI-RS availability indication, P bits, where P is fixed or, configured by higher layer. Alternatively, P is identical to the number of “Reserved bits” of a paging DCI whose CRC is scrambled by P-RNTI. Alternatively, P is identical to the number of bits used for TRS/CSI-RS availability indication within “Reserved bits” of the paging DCI whose CRC is scrambled by P-RNTI. This identical number of bits is useful to ensure the same function between these two channels. P is 8 for shared spectrum access, otherwise P is 6. Alternatively, Q bits out of P bits are used to indicate TRS/CSI-RS availability (1≤Q≤P) based on bitmap or codepoint as the following tables.
Reserved bits, M bits, where M is fixed or, configured by higher layer. Alternatively, M can be zero (i.e., there is no “Reserved bits”).

Table 22, 23, and 24 below show some example paging and/or other information interpretations.

TABLE 22
Example Paging or Other Information Interpretation

| Q = 6 bit, P = 6 bit, i.e., | |
|---|---|
| all bits from P bits | |
| are used) | Interpretation |
| First bit | Address the first TRS/CSI-RS resource |
| Second bit | Address the second TRS/CSI-RS resource if exist. |
| Third bit | Address the third TRS/CSI-RS resource if exist. |
| Fourth bit | Address the fourth TRS/CSI-RS resource if exist. |
| Fifth bit | Address the fifth and sixth TRS/CSI-RS resource if exist. |
| Sixth bit | Address the seventh and eighth TRS/CSI-RS resource if exist. |

TABLE 23
Example Paging or Other Information Interpretation

| Codepoint (Q = 6 bits, P = 6 bits, | |
|---|---|
| all bits from P bits are used) | Interpretation |
| 0 | Address the first group of TRS/CSI-RS resource. |
| 1 | Address the second group of TRS/CSI-RS resource. |
| 2 | Address the third group of TRS/CSI-RS resource |
| | Address the D^{th} group of TRS/CSI-RS resource. |
| . | . |
| . | . |
| . | . |
| . | . |
| 63 | Address the 63^{rd} group of TRS/CSI-RS resource |

TABLE 24
Example Paging or Other Information Interpretation

| Codepoint (Q = 6 bits, P = 6 | |
|---|---|
| bits, all bits from P bits are used) | Interpretation |
| 0 | Address the first group of TRS/CSI-RS resource. |
| 1 | Address the second group of TRS/CSI-RS resource. |
| 2 | Address the third group of TRS/CSI-RS resource |
| 3 | Address the fourth group of TRS/CSI-RS resource |
| . | . |
| . | . |
| 7 | Address the eighth group of TRS/CSI-RS resource |
| 8 | Address the nighth group of TRS/CSI-RS resource |
| | Or reserved for FR 1 or, address all groups. |
| 9 | Address the tenth group of TRS/CSI-RS resource |
| | Or reserved for frequency range (FR) 1 or, address |
| | none of group for FR 1. |
| . | . |
| . | . |
| 63 | Address the 63^{rd} group of TRS/CSI-RS resource |
| | Or reserved for FR 1 for FR 1. |

In one implementation, when the CRC of the DCI is scrambled by P-RNTI or an RNTI configured by higher layer (e.g., RRC), this DCI may include the following bit fields:
paging indication, N bits, where N is configured by higher layer. Alternatively, N=8. Alternatively, N=16. Each bit corresponds to a paging group (or UE group).
TRS/CSI-RS availability indication, P bits, where P is fixed or configured by higher layer. Alternatively, P equals to the number of “Reserved bits” of a paging DCI whose CRC is scrambled by P-RNTI. Alternatively, P equals to the number of bits used for TRS/CSI-RS availability indication within “Reserved bits” of the paging DCI whose CRC is scrambled by P-RNTI. Alternatively, Q bits out of P bits are used to indicate TRS/CSI-RS availability (1≤Q≤P) based on bitmap or codepoint as the following tables.
Short Messages Indicator, one bit. A bit “1” one indicates there is Short Messages while “0” indicates there is no Short Messages.
Short Messages, 8 bits. If the “Short Messages Indicator” above is “0”, this bit field is reserved.
Reserved bits, M bits, where M is fixed or configured by higher layer. Alternatively, the M can be zero (i.e., there is no “Reserved bits”).

In one implementation, when the CRC of the DCI is scrambled by P-RNTI or an RNTI configured by higher layer (e.g., RRC), this DCI may include the following bit fields:
paging indication, N bits, where N is configured by higher layer. Alternatively, N=8. Alternatively, N=16. Each bit corresponds to a paging group (or UE group).
TRS/CSI-RS availability indication, P bits, where P is fixed or configured by higher layer. Alternatively, P equals to the number of “Reserved bits” of the paging DCI. Alternatively, P equals to the number of bits used for TRS/CSI-RS availability indication within “Reserved bits” of the paging DCI. Alternatively, Q bits out of P bits are used to indicate TRS/CSI-RS availability (1≤Q≤P) based on bitmap or codepoint. Alternatively, for different frequency range (FR), the corresponding value P might be different. Alternatively, for different frequency range (FR), the number of bits within P bits used for indicating TRS/CSI-RS availability might be different. For example, for P=6 bits, for FR1, only T=3 bits of P bits are used to indicate TRS/CSI-RS availability, and the other P−T=3 bits are reserved. For FR2, all the P bits may be used to indicate TRS/CSI-RS availability.
Short Messages, S=8 bits. When all bits are set to zero, it means there is no short message from higher layer. Alternatively, the bit-width of this field may be determined as the valid number of bits of Short Messages (e.g., S=3). Alternatively, the bit-width may be the valid number of bits of Short Messages plus some predefined value (e.g., one to five. e.g., S=4).
Reserved bits, M bits, where M is fixed or configured by higher layer. Alternatively, the M can be zero (i.e., there is no “Reserved bits”).

In one implementation, when the CRC of the DCI is scrambled by P-RNTI or an RNTI configured by higher layer (e.g., RRC), this DCI may include the following bit fields
paging indication or TRS/CSI-RS availability indication, N bits, where N is configured by higher layer. Alternatively, one bit (e.g., the first bit) out of the N bits may indicate whether the DCI is for paging indication or TRS/CSI-RS availability indication. For example, there is N=9 bits, if the first bit is “1”, the remaining N−1=8 bits may be paging indication. Otherwise, the remaining N−1=8 bits may be TRS/CSI-RS availability indication. Alternatively, for TRS/CSI-RS availability indication (e.g., when the first bit of N bits is “0”), only M bits of N−1 bits are used for TRS/CSI-RS availability indication. Where M is a positive integer, 0<M<N, e.g. M=6. Alternatively, for TRS/CSI-RS availability indication (e.g., when the first bit of N bits is “0”), only M bits of N−1 bits are used for TRS/CSI-RS availability indication while the last N−1−M is reserved. Alternatively, for TRS/CSI-RS availability indication (e.g., when the first bit of N bits is “0”), only the first M bits of N−1 bits are used for TRS/CSI-RS availability indication while the last N−1−M are reserved or for other purpose (e.g., SI change, ETWS, short messages).

In one implementation, when the CRC of the DCI is scrambled by P-RNTI or an RNTI configured by higher layer (e.g., RRC), this DCI may have N bits in total and it may include the following bit fields, where N is configured by higher layer (e.g., N=12).
paging indication, M bits, where M is an integer, 0<M<N, e.g., M=8. Each bit corresponds to a paging group (or UE group).
TRS/CSI-RS availability indication, N-M bits, e.g., N-M=4. Alternatively, a codepoint indication is applied with these N-M bits. Alternatively, a codepoint will indicate an entry to a list or a table that is configured by higher layer. For example, as shown in Table 5 below, each codepoint corresponds to an indication interpretation.

In one implementation, when the CRC of the DCI is scrambled by P-RNTI or an RNTI configured by higher layer (e.g., RRC), this DCI may have the following bit field:
Reserved bits: V=8 bits for operation in a cell with shared spectrum channel access; otherwise V=6 bits. In addition, these bits can be used for indication of TRS/CSI-RS availability. It should be noted that, a default state should be assumed. For example, a TRS/CSI-RS resource is available (or unavailable) before it is addressed. If there are less than U=6 bits configured for TRS/CSI-RS availability indication, then V-U bit(s) is/are reserved. Alternatively, if there are less than U=6 bits, then V-U bit(s) is/are used for Short Message (or, SI change indication). Alternatively, a bitmap is used to represent TRS/CSI-RS availability indication where TRS/CSI-RS occasion(s) for different beam direction are grouped into U=6 or less groups and, each bit represents a group of TRS/CSI-RS occasion(s) or TRS/CSI-RS beam direction.

Table 25 and 26 below show some example paging and/or other information interpretations.

TABLE 25
Example Paging or Other Information Interpretation

| Codepoint (U = 6 Bit) | Interpretation |
|---|---|
| 0 | Address the first group of TRS/CSI-RS resource. |
| 1 | Address the second group of TRS/CSI-RS resource. |
| 2 | Address the third group of TRS/CSI-RS resource |
| 7 | Address the eighth group of TRS/CSI-RS resource |
| . | . |
| . | . |
| . | . |
| . | . |
| 63 | Address the 64^{th} group of TRS/CSI-RS resource |
| | Or reserved for FR 1. |

TABLE 26
Example Paging or Other Information Interpretation

| Codepoint (U = 6 Bit) | Interpretation |
|---|---|
| 0 | Address the first group of TRS/CSI-RS resource. |
| 1 | Address the second group of TRS/CSI-RS resource. |
| . | . |
| . | . |
| 7 | Address the eighth group of TRS/CSI-RS resource. |
| 8 | Address the nighth group of TRS/CSI-RS resource. |
| | Or reserved for FR 1 or, address all groups. |
| 9 | Address the tenth group of TRS/CSI-RS resource. |
| | Or reserved for frequency range (FR) 1 or, address |
| | none of group for FR 1. |
| . | . |
| . | . |
| 61 | Address the 62-64^{th} group of TRS/CSI-RS resource. |
| 62 | Address all groups of TRS/CSI-RS resource for FR |
| | 2. |
| | Or reserved for FR 1 for FR 1. |
| 63 | Address none of group of TRS/CSI-RS resource for |
| | FR 2 (e.g., none of group of TRS/CSI-RS resource is |
| | available). |
| | Or reserved for FR 1. |

In one implementation, when the CRC of the DCI is scrambled by P-RNTI or an RNTI configured by higher layer (e.g., Medium Access Control, MAC), if the DCI has identical DCI size to that of DCI format 1_0, then the bit(s) in the DCI corresponding to the MCS bit of another DCI (e.g., the 25th-29th bit, i.e., the bits corresponding to the MCS bits of DCI format 1_0 that is scrambled by P-RNTI, in a CORESET with 24 RB) is/are set a predefined value (e.g., all one in binary, “11111”). The bit correspondence may be established by a bit index in each DCI (i.e., the first bit in the DCI corresponds to the first bit in another DCI).

In one implementation, when the CRC of the DCI is scrambled by P-RNTI or an RNTI configured by higher layer (e.g., RRC), this DCI maybe transmitted in search space zero (SS0). Alternatively, when the CRC of the DCI is scrambled by a P-RNTI or an RNTI configured by higher layer, this DCI maybe transmitted in PagingSearchSpace that carries paging DCI (or paging-PDCCH). Alternatively, when the CRC of the DCI is scrambled by P-RNTI or an RNTI configured by higher layer, this DCI maybe transmitted in a common search space that is configured by higher layer. Alternatively, when the CRC of the DCI is scrambled by a P-RNTI or an RNTI configured by higher layer, this DCI maybe transmitted in PEISearchSpace which may be configured as SS0 or PagingSearchSpace. Alternatively, when the CRC of the DCI is scrambled by a P-RNTI or an RNTI configured by higher layer, this DCI maybe transmitted in a common search space or PEISearchSpace.

With embodiments of this disclosure, the paging group, and/or TRS/CSI-RS availability, and/or Short Messages will be addressed. With the implementation of the paging indication as disclosed in this disclosure, a UE under idle of inactive state may save power consumption.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method performed by a User Equipment (UE) in a wireless network, wherein the UE is in an idle or an inactive state, the method comprising:
receiving a Downlink Control Information (DCI) from a wireless communication node in the wireless network, wherein the DCI is scramble by a Radio Network Temporary Identification (RNTI) and comprises a paging indication, and wherein the paging indication indicates whether the UE is to receive a next coming paging occasion;
resolving the paging indication from the DCI in response to determining that a predetermined condition is met, wherein:
the predetermined condition comprises a Cyclic Redundancy Check (CRC) of the DCI being scrambled by a paging RNTI (P-RNTI) or an RNTI configured by higher layer; and
the DCI is characterized by at least one of:
a paging indication field comprising N bits, wherein N is an integer which is pre-determined or configured by higher layer; or
a TRS/CSI-RS availability indication field comprising P bits, wherein P is an integer which is pre-determined or configured by higher layer; and
determining whether the UE is to receive the next coming paging occasion based on the paging indication.

2. The method of claim 1, further comprising:
in response to determining that the UE needs to receive the next coming paging occasion, receiving the next coming paging occasion.

3. The method of claim 1, wherein determining whether the UE is to receive the next coming paging occasion based on the paging indication comprises:
in determination that the paging indication indicates a paging group that the UE belongs to, determining that the UE is to receive the next coming paging occasion.

4. The method of claim 1, wherein the DCI comprises a channel state information reference signal availability indication.

5. The method of claim 1, wherein:
the DCI comprises at least one non-reserved field from a first field set, and the first field set comprises at least one of:
a Transport Block (TB) scaling field;
a Short Messages Indicator field;
a Short Messages field;
a Frequency domain resource assignment field;
a Time domain resource assignment field;
a Virtual Resource Block to Physical Resource Block (VRB-to-PRB) mapping field; or
a Modulation and Coding Scheme (MCS) field; and
the predetermined condition comprises the at least one non-reserved field being set to a predetermined value.

6. The method of claim 5, wherein at least one of following conditions is satisfied:
the at least one non-reserved field comprises the TB scaling field, and the predetermined value is binary “11”;
the predetermined value is determined by setting all bits of the at least one non-reserved field to 0;
the at least one non-reserved field comprises the MCS field, and the predetermined value comprises an integer in the range of 8 and 31, inclusive; or
the at least one non-reserved field comprises one of the Frequency domain resource assignment field and the Time domain resource assignment field, and the predetermined value is determined by setting all bits of the at least one non-reserved field to 1.

7-9. (canceled)

10. The method of claim 1, wherein the paging indication comprises up to 8 bits, each of the 8 bits corresponding to a paging group, and wherein when a bit of the paging indication is set to 1, UEs in the corresponding paging group are to receive the next coming paging DCI.

11. (canceled)

12. The method of claim 1, wherein the paging indication is carried in at least one of a reserved bits field of the DCI or a non-reserved field of the DCI, and wherein resolving the paging indication from the DCI comprises resolving the paging indication from at least one of the reserved bits field or the non-reserved field.

13. The method of claim 12, wherein at least one of following conditions is satisfied:
at least a portion of the paging indication is carried in a VRB-to-PRB mapping field of the DCI;
at least a portion of the paging indication is carried in an MCS field of the DCI;
at least a portion of the paging indication is carried in a subset of all bits in the MCS field of the DCI; or
a subset of all bits in the paging indication indicates channel state information reference signal (CSI-RS) availability.

14-18. (canceled)

19. The method of claim 1, wherein P equals to a bit number of a reserved bits field of a paging DCI, and wherein a CRC of the paging DCI is scramble by a P-RNTI.

20. The method of claim 1, wherein P equals to a bit number of indication bits within a reserved bits field of a paging DCI, the indication bits being used for TRS/CSI-RS availability indication, and a CRC of the paging DCI being scramble by a P-RNTI.

21. A method performed by a wireless communication node in a wireless network, comprising:
determining whether a predetermined condition is met; and
in response to the predetermined condition being met, transmitting a Downlink Control Information (DCI) to a UE in the wireless network, wherein the DCI is scramble by a Radio Network Temporary Identification (RNTI) and comprises a paging indication, and wherein the paging indication indicates whether the UE is to receive a next coming paging occasion.

22. The method of claim 21, wherein the DCI comprises a channel state information reference signal availability indication.

23. The method of claim 21, wherein:
the DCI comprises at least one non-reserved field from a first field set, and the first field set comprises at least one of:
a Transport Block (TB) scaling field;
a Short Messages Indicator field;
a Short Messages field;
a Frequency domain resource assignment field;
a Time domain resource assignment field;
a Virtual Resource Block to Physical Resource Block (VRB-to-PRB) mapping field; or
a Modulation and Coding Scheme (MC S) field; and
the predetermined condition comprises the at least one non-reserved field being set to a predetermined value.

24. The method of claim 23, wherein at least one of following conditions is satisfied:
the at least one non-reserved field comprises the TB scaling field, and the predetermined value is binary “11”;
the predetermined value is determined by setting all bits of the at least one non-reserved field to 0;
the at least one non-reserved field comprises the MCS field, and the predetermined value comprises an integer in the range of 8 and 31, inclusive; or
the at least one non-reserved field comprises one of the Frequency domain resource assignment field and the Time domain resource assignment field, and the predetermined value is determined by setting all bits of the at least one non-reserved field to 1.

25-27. (canceled)

28. The method of claim 21, wherein the paging indication comprises up to 8 bits, each of the 8 bits corresponding to a paging group, and wherein when a bit of the paging indication is set to 1, UEs in the corresponding paging group are to receive the next coming paging DCI.

29-38. (canceled)

39. A User Equipment (UE) in a wireless network, comprising a memory for storing computer instructions and a processor in communication with the memory, wherein, when the processor executes the computer instructions, the processor is configured to cause the UE to:
receive a Downlink Control Information (DCI) from a wireless communication node in the wireless network, wherein the DCI is scramble by a Radio Network Temporary Identification (RNTI) and comprises a paging indication, and wherein the paging indication indicates whether the UE is to receive a next coming paging occasion;
resolve the paging indication from the DCI in response to determining that a predetermined condition is met, wherein:
the predetermined condition comprises a Cyclic Redundancy Check (CRC) of the DCI being scrambled by a paging RNTI (P-RNTI) or an RNTI configured by higher layer; and
the DCI is characterized by at least one of:
a paging indication field comprising N bits, wherein N is an integer which is pre-determined or configured by higher layer; or
a TRS/CSI-RS availability indication field comprising P bits, wherein P is an integer which is pre-determined or configured by higher layer; and
determine whether the UE is to receive the next coming paging occasion based on the paging indication.

40-42. (canceled)

43. A computer program product comprising a non-transitory computer-readable program medium with computer code stored thereupon, the computer code, when executed by one or more processors, causing the one or more processors to implement a method of claim 1.

44. A device for wireless communication comprising a memory for storing computer instructions and a processor in communication with the memory, wherein, when the processor executes the computer instructions, the processor is configured to implement a method in claim 21.

45. A computer program product comprising a non-transitory computer-readable program medium with computer code stored thereupon, the computer code, when executed by one or more processors, causing the one or more processors to implement a method of claim 21.
